(19) United States
(12) Patent Application Publication
(10) Pub. No.: US 2009/0297130 A1
(43) Pub. Date: Dec. 3, 2009

(54) RECORDING/REPRODUCING METHOD AND APPARATUS

(75) Inventors: Satoshi Otsuka, Yokohama (JP); Takashi Matsubara, Yokohama (JP); Sadao Tsuruga, Yokohama (JP); Noboru Wakabayashi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/431,055

(22) Filed: Apr. 28, 2009

(30) Foreign Application Priority Data
May 29, 2008 (JP) 2008-140989

(51) Int. Cl. H04N 7/26

(52) U.S. Cl. 386/124

(57) ABSTRACT

Necessary information on an action, which is performed in the case where a reproducing position overtakes a recording position during follow-up reproduction, is provided for a user. An action the user desires can be automatically or readily carried out. A reproducible time is calculated during a reproducing action. If the reproducible time is equal to or smaller than a predetermined value, a warning message is displayed for the user. When the reproducible time becomes equal to or smaller than the predetermined value and a breakpoint in a content comes within the reproducible time, reproduction is suspended at the breakpoint. When the reproducible time becomes equal to or smaller than the predetermined time, a picture is switched to a temporary-reproduction content.

### CLAIM OF PRIORITY

The present application claims priority from Japanese patent application serial no. JP 2008-140989, filed on May 29, 2008, the content of which is hereby incorporated by reference into this application.

### BACKGROUND OF THE INVENTION

1. Field of the Invention

The present invention relates to an apparatus that records and reproduces digital information, or more particularly, to an apparatus capable of concurrently performing recording and reproduction.

2. Description of the Related Art

Regarding apparatuses that record and reproduce information on a picture and sounds, more and more of them have come to have the ability to reproduce information, which has already been recorded, while recording certain information.

In JP-A-7-141775, a recording/reproducing apparatus that uses a disk-like recording/reproducing medium to concurrently perform recording and reproduction of compressed motion-picture information is disclosed.

In JP-A-2007-89214, a drawback that when recording is performed and follow-up reproduction is concurrently performed at a high speed, if a reproducing position overtakes a recording position, a reproduced picture is disturbed is described to be solved by canceling a high-speed reproduction action so as to suspend reproduction.

### SUMMARY OF THE INVENTION

In recent years, the way of viewing a video content has been diversified. Not only watching the television by receiving a conventional analog broadcast but also receiving a broadcast of a high-quality content through terrestrial digital broadcasting, receiving an Internet Protocol (IP) broadcast at a personal computer (PC) over the Internet, and receiving a video content at a network-compatible television have prevailed. Distribution of a digital content responsive to a request made by a user, that is, video-on-demand distribution has become a matter of general interest.

For receiving a video content over a network, an infrastructure such as the Internet generally has difficulty in distributing data to users at a stable speed. Therefore, in the case of streaming reproduction in which reception of data and display of a picture are performed concurrently, data to be received does not come in time for display of a picture, though it depends on the state of a communication link. This poses a problem in that viewing is hindered because, for example, a picture stops frequently. There is a method which is a form of download reproduction and in which: a video content is accumulated in receiving equipment; and after the accumulation is completed, viewing is enabled.

However, a recent video content has a very large data size due to high image quality thereof. It therefore may take a long time to complete accumulation. In such a case, a method of enabling viewing while performing accumulation is required. While information is recorded, information having been recorded is reproduced. This poses a problem in that a reproducing position overtakes a recording position and a reproduced picture is disturbed, though it depends on the state of a communication link.

In JP-A-7-141775, the above problem is not taken into account.

In JP-A-2007-89214, when a reproducing position overtakes a recording position during follow-up reproduction, even if a climax of a movie is viewed, the picture is suddenly freeze-framed. How much time a viewer should wait until the picture is restarted after being freeze-framed is unknown. A user waits for the restart while watching the still image or performs manipulations by himself/herself so as to switch the content to another.

An object of the present invention is to solve the foregoing problems and to provide a recording/reproducing method and apparatus that provides a user with necessary information concerning an action to be performed when a reproducing position overtakes a recording position during follow-up reproduction, and that allows the user to perform a desired action.

In order to accomplish the foregoing object, the present invention provides a recording/reproducing method for recording information on an input picture or sounds in a recording medium and concurrently reproducing recorded information from the recording medium so as to output the information to outside. Herein, the recording/reproducing method includes: a first calculation step of calculating a reproducible time during which information can be reproduced until a reproducing position overtakes a recording position; a comparison step of comparing the reproducible time with a predetermined value; and a control step of controlling a recording/reproducing action. If a decision is made at the comparison step that the reproducible time is equal to or smaller than the predetermined value, reproduction is suspended at the control step.

The present invention provides a recording/reproducing apparatus that records information on an input picture or sounds in a recording medium and concurrently reproduces recorded information from the recording medium so as to output the information to outside. Herein, the recording/reproducing apparatus includes: a reproducible time calculation unit that calculates a reproducible time during which information can be reproduced until a reproducing position overtakes a recording position; a reproducible time comparison unit that compares the reproducible time with a predetermined value; and a recording/reproducing control unit that controls a recording/reproducing action. If a decision is made in the reproducible time comparison unit that the reproducible time is equal to or smaller than the predetermined value, the recording/reproducing control unit suspends reproduction.

The present invention has the advantage that the user's convenience in suspending follow-up reproduction can be improved.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing an example of the configuration of a recording/reproducing apparatus in accordance with a first embodiment;

FIG. 2 is an illustrative diagram showing the details of a recording/reproducing control unit included in the recording/reproducing apparatus in accordance with the first embodiment;

FIG. 3 is an example of a flowchart describing a calculating method for a reproducible time;

FIG. 4 is an illustrative diagram explaining the reproducible time;

FIG. 5 is an example of a flowchart describing a process of displaying a warning message for a user in accordance with the present invention;

FIG. 6 shows an example of display of a message in accordance with the first embodiment;

FIG. 7 shows an example of display of a message in accordance with the first embodiment;

FIG. 8 is a block diagram showing an example of a configuration of a recording/reproducing apparatus in accordance with a second embodiment;

FIG. 9 is an example of a flowchart describing a process of displaying a warning message for a user in accordance with the second embodiment;

FIG. 10 shows an example of display of a message in accordance with the second embodiment;

FIG. 11 is an example of a flowchart describing a process in accordance with the second embodiment which is carried out when a suspension point is reached;

FIG. 12 shows an example of display of a message in accordance with the second embodiment;

FIG. 13 shows an example of display of a message in accordance with the second embodiment;

FIG. 14 shows an example of pieces of information on breakpoints;

FIG. 15 shows an example of display of a message in accordance with a third embodiment;

FIG. 16 shows an example of display of a message in accordance with the third embodiment;

FIG. 17A is an example of a flowchart describing a process to be performed according to the third embodiment when a user designates a suspension-time action;

FIG. 17B is an example of a flowchart describing a process to be performed according to the third embodiment when a user designates a suspension-time action;

FIG. 18 shows an example of display of a message in accordance with the third embodiment;

FIG. 19 shows an example of display of a message in accordance with the third embodiment;

FIG. 20 is an example of a flowchart describing a process to be performed at a suspension reset processing time according to the third embodiment;

FIG. 21 shows an example of display of a message in accordance with the third embodiment;

FIG. 22 shows an example of display of a message in accordance with the third embodiment;

FIG. 23 is an example of a flowchart describing a process to be performed at a suspension reset processing time according to the third embodiment;

FIG. 24 is a block diagram showing an example of the configuration of a recording/reproducing apparatus in accordance with a fourth embodiment;

FIG. 25 is an example of a flowchart describing a process of displaying a warning message for a user in accordance with the fourth embodiment;

FIG. 26 shows an example of display of a message in accordance with the fourth embodiment;

FIG. 27 is an example of a flowchart describing a calculating method for an estimated restoration time;

FIG. 28 is an illustrative diagram concerning the estimated restoration time;

FIG. 29 is an example of a flowchart describing a process to be performed at a suspension time according to the fourth embodiment;

FIG. 30 shows an example of display of a message in accordance with the fourth embodiment;

FIG. 31 is an example of a flowchart describing a calculating method for a restorable time; and

FIG. 32 is an example of a flowchart describing a process of automatically deciding a suspended-time action using the estimated restoration time in accordance with the fourth embodiment.

### DESCRIPTION OF THE EMBODIMENTS

Preferred embodiments of the present invention will be described in conjunction with the drawings. However, the present invention is not limited to the embodiments. For example, although the embodiments will be described in relation to a recording/reproducing method and apparatus, the applications of the present invention to methods and apparatuses other than the recording/reproducing method and apparatus will not be hindered. For example, the present invention can be applied to an apparatus, to which a recording/reproducing function as well as a communication function is added, such as an up-to-date portable cellular phone. All of the constituent features of the embodiments need not be adopted but any of the constituent features thereof can be chosen.

### First Embodiment

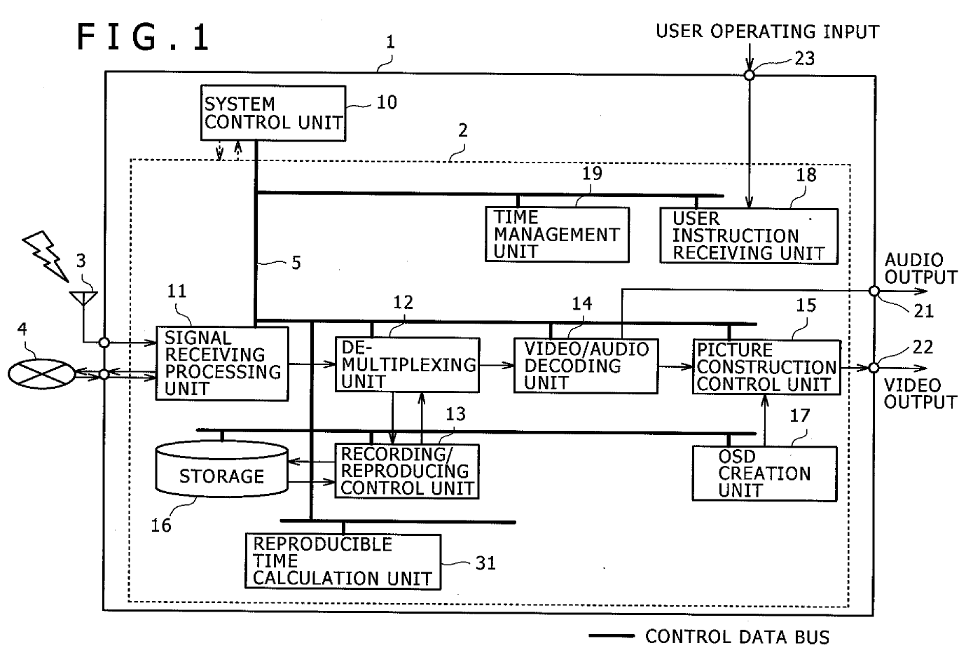

FIG. 1 shows the configuration of a recording/reproducing apparatus in accordance with the first embodiment of the present invention.

The first embodiment is characterized in that: when a reproducing position overtakes a recording position during follow-up reproduction, if there is a possibility that a reproducible time may become equal to or smaller than a certain (predetermined) time and a picture may be freeze-framed, a message is presented to a user in advance so that the user can prepare for the freeze-frame of the picture. Therefore, a reproducible time calculation unit 31 is included as detailed later.

A recording/reproducing apparatus 1 includes: a system control unit 10 that controls the whole of the apparatus; a signal receiving processing unit 11 that receives a digital signal from an antenna 3 or a network 4, performs channel selection, digital demodulation, error correction, and others, and outputs a signal such as a transport stream (TS) conformable to the MPEG-2 standards; a demultiplexing unit 12 that performs demultiplexing processing to separate the TS into a stream composed of a picture, sounds, caption, and program information, or performs descrambling processing; a recording/reproducing control unit 13 that controls reproducing and reproduction, and controls reading or writing of data from or in a storage; a video/audio decoding unit 14 that decodes an encoded video stream (hereinafter, a video packetized elementary stream (PES)) or an encoded audio stream (hereinafter, an audio PES) into a picture or sounds; an OSD creation unit 17 that creates an on-screen display (OSD) such as a display containing a menu or a message; a screen construction control unit 15 that performs superposition of a picture and the OSD or performs scaling or the like according to a signal to be inputted and a picture to be outputted; a storage 16 (for example, a hard disk drive (HDD), a digital versatile disk (DVD), an SD memory card, or a Blu-ray disc (BD)) in which a TS containing a picture and sounds and supplementary information relevant to the picture and sounds are stored; a user instruction receiving unit 18 that receives and interprets the contents of an instruction entered by a user (for example, by depressing a button on a remote control); and a time management unit 19 that is responsible for control relating to a time or a time instant, that is, manages a current time instant or notifies of the fact that a certain time has elapsed. Herein, a dot line 2 defines a control range to be controlled by the system control unit 10. Namely, the units surrounded with the dot line 2 are connected to the system control unit 10 over a certain communication link (for example, a control data bus 5 such as a PCI bus), and the units can directly communicate with one another or indirectly communicate with one another via the system control unit 10.

Next, the actions will be described below. To begin with, a description will be made of recording processing to be performed in the recording/reproducing apparatus 1 in order to receive a digital signal and record a signal carrying a specific picture or/and sounds. The system control unit 10 instructs the signal receiving processing unit 11 to select a channel so as to receive a specific digital signal. If the channel selection instruction signifies reception of, for example, a terrestrial digital broadcast, the signal receiving processing unit 11 having received the channel selection instruction performs channel selection, digital demodulation, and error correction, and acquires a TS from the digital signal. If the channel selection instruction signifies reception of, for example, an Internet broadcast (Internet Protocol television (IPTV)), the signal receiving processing unit 11 requests data acquisition from a specific uniform resource locator (URL), performs protocol processing, error correction, and retransmitting processing, and acquires a TS from the digital signal. The signal receiving processing unit 11 having acquired the TS outputs the TS to the demultiplexing unit 12. The demultiplexing unit 12 having inputted the TS de-multiplexes the TS according to the instruction sent from the system control unit 10 so as to produce a TS, which contains a picture or/and sounds and is an object of recording, and outputs the TS to the recording/reproducing control unit 13. Thus, the TS that contains a picture or/and sounds and is an object of recording is stored in the storage.

Reproducing processing of reproducing a TS recorded in the storage and outputting a picture and/or sounds, which is performed in the recording/reproducing apparatus 1, will be described below. To begin with, the user instruction receiving unit 18 having received a signal inputted from a user operating input unit 23 (for example, a remote-control code entered by operating a remote control) interprets the signal, and transmits an interpreted user instruction to the system control unit 10. The system control unit 10 having received the user instruction performs processing according to the contents of the user instruction. Herein, a description will be made on the assumption that the user instruction is a reproduction request. The system control unit 10 having received the reproduction instruction instructs the recording/reproducing control unit 13 to reproduce a TS containing a specific picture and/or sounds. The recording/reproducing control unit 13 having received the reproduction instruction acquires the TS, which contains the specific picture and sounds and is recorded, from the storage 16, and outputs the TS to the demultiplexing unit 12. The demultiplexing unit 12 having received the TS from the recording/reproducing control unit 13 performs demultiplexing and outputs a video PES and/or an audio PES to the video/audio decoding unit 14. The video/audio decoding unit 14 decodes the video PES and/or audio PES, outputs decoded sounds to an audio output unit 21, and outputs a decoded picture to the screen construction control unit 15. The OSD creation unit 17 creates an OSD according to an instruction received from the system control unit 10, and outputs the OSD to the screen construction control unit 15. As the OSD, for example, when reproduction is under way, an OSD presenting a reproducing position in a content currently being reproduced is created and outputted. The screen construction control unit 15 produces a picture having the OSD superposed on the decoded picture, and outputs the resultant picture to a video output unit 22. Thus, the TS recorded in the storage is reproduced, and the picture and sounds are outputted.

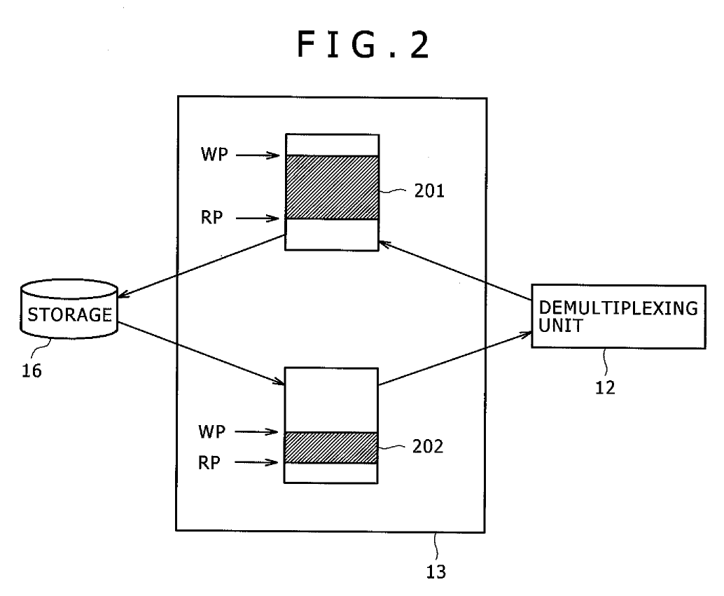

Buffering processing to be performed in the recording/reproducing control unit 13 during recording or reproduction will be described below. The recording/reproducing control unit 13 includes, as shown in FIG. 2, a recording buffer 201 and a reproduction buffer 202. The axis of ordinates in each of the buffers indicates addresses, and the address values get larger at upper points on the axis of ordinates. The buffers are supposed to be circulatory buffers (ring buffers) in which when an address reaches an uppermost point, the next address is allocated to a lowermost point. Reference numeral WP denotes a write pointer that indicates a data writing position, and reference numeral RP denotes a read pointer that indicates a data reading position. Data is recorded between the write pointer and read pointer (hatched area in the drawing). Buffering processing to be performed during reproduction will be described below. In the reproduction buffer 202, a TS which the recording/reproducing control unit 13 has read from the storage 16 is recorded. The recording/reproducing control unit 13 writes the data of the TS, which is read from the storage 16, at the position of the write pointer WP in the reproduction buffer 202. Every time writing is completed, the value indicated by the write pointer WP is incremented by the data size. The recording/reproducing control unit 13 outputs the data to the demultiplexing unit 12. The recording/reproducing control unit 13 reads data from the position of the read pointer RP in the reproduction buffer 202. Every time outputting the read data is completed, the value indicated by the read pointer RP is incremented by the data size. The same processing is performed on the recording side buffer during recording. Thus, the recording/reproducing control unit 13 performs buffering processing on data so as to lessen a difference in a data transfer rate between an inputting side and an outputting side.

Concurrent recording reproduction in which recording and reproduction are concurrently performed can be achieved by concurrently executing the recording processing and reproducing processing. Herein, concurrently executing the recording processing and reproducing processing for the same content shall be called follow-up reproduction.

In follow-up reproduction, since recording and reproduction of the same content are concurrently performed, if a reproducing speed is higher than a recording speed at which data is recorded per unit time in the storage 16, a reproducing position may overtake a recording position. Since the reproducing position will not pass the recording position, a method for bringing reproduction to a suspended state is adopted in such a situation.

Reproduction suspending processing in the recording/reproducing apparatus 1 will be described below. For suspending reproduction, the system control unit 10 instructs the recording/reproducing control unit 13 to suspend reproduction. The recording/reproducing control unit 13 having received the instruction ceases reading of a content from the storage, and records a current reproducing position as a resume point. At this time, the system control unit 10 instructs the video/audio decoding unit 14 or screen construction control unit 15 to freeze a currently reproduced picture. The video/audio decoding unit 14 or screen construction control unit 15 having received the instruction repeatedly outputs the same signal as the current picture, whereby a picture outputted to a user looks like being a still image. For freezing the picture, when an input signal runs out, if the video/audio decoding unit 14 or screen construction control unit 15 repeatedly outputs an immediately preceding picture frame, the picture would be automatically freeze-framed. In this case, the freeze instruction need not be issued from the system control unit 10 to the video/audio decoding unit 14 or screen construction control unit 15. Thus, suspension of reproduction is achieved.

Resuming processing to be initiated in a suspended state will be described below. When the system control unit 10 instructs the recording/reproducing control unit 13 to resume reproduction, the recording/reproducing control unit 13 resumes at the resume point reading of a content from the storage 16. If the system control unit 10 has issued the freeze instruction to the video/audio decoding unit 14 or screen construction control unit 15, the freeze instruction is canceled. Thus, reproduction is resumed in the suspended state.

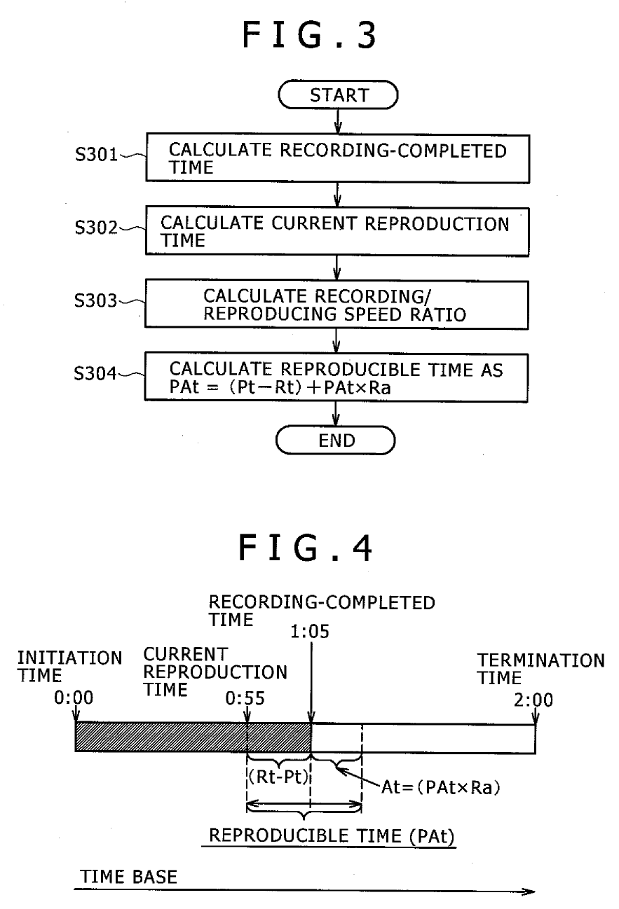

Next, a calculating method for a reproducible time that is implemented in the reproducible time calculation unit 31 and that is a feature of the present embodiment will be described in conjunction with the flowchart of FIG. 3. What is referred to as the reproducible time is a time within which a reproducing position presumably overtakes a recording position in case follow-up reproduction is carried on in a current state.

To begin with, the reproducible time calculation unit 31 requests the recording/reproducing control unit 13 for a recording-completed time (Rt) concerning a currently reproduced content (S301). What is referred to as the recording-completed time is a time within which part of a content having been recorded so far can be reproduced when being reproduced at a normal speed. For instance, assuming that the bit rate of a content is 7 Mbits/sec and a recorded size of the content is 700 Mbits, a quotient of the recording-completed size of the content by the bit rate of a picture, that is, 100 sec is calculated as the recording-completed time. As the other calculating methods for the recording-completed time, there are methods of calculating a difference time between a recording initiation time to a current time in the case where a reproducing speed for a content represented by a stream is equal to a recording speed for a picture (for example, in the case of recording a digital broadcast), calculating a difference time between a leading time stamp and a time stamp at a position currently being recorded in the case where the time stamp is appended to a stream representing a content, or calculating a time on the basis of a time or a time instant specified in a stream (for example, a difference between a time instant at a leading position and a time offset table (TOT) at a current position or metadata signifying how many minutes have elapsed since a time instant at a leading position).

Thereafter, the reproducible time calculation unit 31 requests the recording/reproducing control unit 13 for a current reproduction time (Pt) (S302). What is referred to as the current reproduction time is a time required for a transition from a leading position to a position currently being reproduced. For example, assuming that a user views a content from the leading position in the content for thirty minutes without performing any manipulation, thirty minutes is the current reproduction time. As for a calculating method for the current reproduction time, a difference time between a time stamp at a leading position in a content and a time stamp at a point currently being reproduced, a time from a time instant when reproduction is actually initiated to a current time instant, or information on a time or a time instant contained in a stream may be used to obtain the current reproduction time.

Thereafter, the reproducible time calculation unit 31 calculates a means recording/reproducing speed ratio Ra for a content (S303). For example, assuming that the bit rate for reproduction of a content is 8 Mbits/sec and the bit rate for recording of the content is 4 Mbits/sec, the speed ratio Ra is calculated as 0.5 by dividing the bit rate for recording of the content by the bit rate for reproduction thereof. As a calculating method for the recording/reproducing speed ratio, there is a method of dividing the bit rate per unit time for a digital signal, which is inputted to the signal receiving processing unit 11, by the bit rate for reproduction of the content acquired from the recording/reproducing control unit 13, or a method of dividing the bit rate for recording of a content in the storage, which is acquired from the recording/reproducing control unit 13, by the bit rate for reproduction of the content which is acquired from the recording/reproducing control unit 13.

Finally, a reproducible time PAt is calculated based on the recording-completed time Rt, current reproduction time Pt, and recording/reproducing speed ratio Ra. As a calculating method for the reproducible time PAt, there is a method in which since the reproducible time PAt corresponds to the sum between a reproduction time (Rt−Pt) for part of a content whose recording is currently completed but which is not yet reproduced, and a reproduction time PAt×Ra for part of the content that will be recorded before a reproducing position overtakes a recording position, the reproducible time PAt is calculated as follows:

PAt=(Rt−Pt)+PAt×Ra

The above equation is rewritten as follows:

PAt=(Rt−Pt)/(1−Ra) (1)

Herein, 0<Ra<1 shall be established. When Ra≧1 is established, the PAt value shall be treaded as an infinite value. At this time, the reproducing position will not overtake the recording position. According to the method, the reproducible time is calculated (S304).

The reproducible time PAt will be described again in conjunction with FIG. 4. A laterally elongated square in the center of FIG. 4 expresses content data. The axis of abscissas indicates times, and the rightward direction is a positive direction. In this example, a content is a content of two hours long. The left-hand end indicates an initiation time, and the right-hand end indicates a termination time. The content of two hours long has part thereof, which takes up one hour and five minutes from the initiation time, recorded. The recorded part of the content data is expressed with a hatched area in the drawing. Follow-up reproduction of the same content is carried out, and the reproduction has been completed up to a time point at which fifty-five minutes has elapsed. Herein, the reproducible time PAt is obtained as the sum of the difference between a recording-completed time and a current reproduction time ((Rt−Pt) in the drawing) and the length of part of the content that is scheduled to be recorded until the reproduction of the content is suspended (=PAt×Ra). The PAt value can be calculated according to the aforesaid equation (1).

As a simple calculating method for the PAt value, there is a calculating method that does not use the Ra value and does not take account of part of a content that is scheduled to be recorded until reproduction of the content is suspended. In this case, the PAt value is calculated as follows:

PAt=Rt−Pt

In this case, since a content to be recorded from now on is not taken into account, even when Ra≧1 is established, if a reproducing position may not overtake a recording position or a message to be described later is unnecessary, there is the demerit that the message is displayed. However, there is the merit that calculation is easy to do.

As the other calculating method for a reproducible time, there is a method using a difference between the read pointer in the reproduction buffer 202 and the write pointer therein. Assuming that PA2t denotes the reproducible time calculated in this method, the reproducible time is a value calculated by dividing a value Dt, which is obtained by subtracting the read pointer from the write pointer, by the bit rate Cr for a content. Namely, the reproducible time PA2t is expressed as follows:

PA2t=Dt/Cr

When Ia denotes the number of inputs per unit time of the reproduction buffer, the above equation is rewritten as follows:

PA2t=(Dt+PA2t×Ia)/Cr

When the equation is further rewritten, the following equation is drawn out:

PA2t=Dt/(Cr−Ia)

The bit rate employed in calculation of the recording/reproducing speed ratio Ra can be calculated by dividing a sum total of input signals, which are inputted to the apparatus within a certain period, by the period. If the period is set to a period from a recording initiation time to a current time, a mean bit rate over a long period is used to calculate a mean value in the specific environment. At this time, if bit rates having been recorded in the past are cumulated in order to calculate a mean bit rate, a further mean value can be calculated. When the period is set to a short period and a bit rate is calculated over several immediately preceding seconds, the bit rate suitable for a current environment can be calculated. An abrupt change in a bit rate attributable to disconnection of a network environment or the like can be coped with.

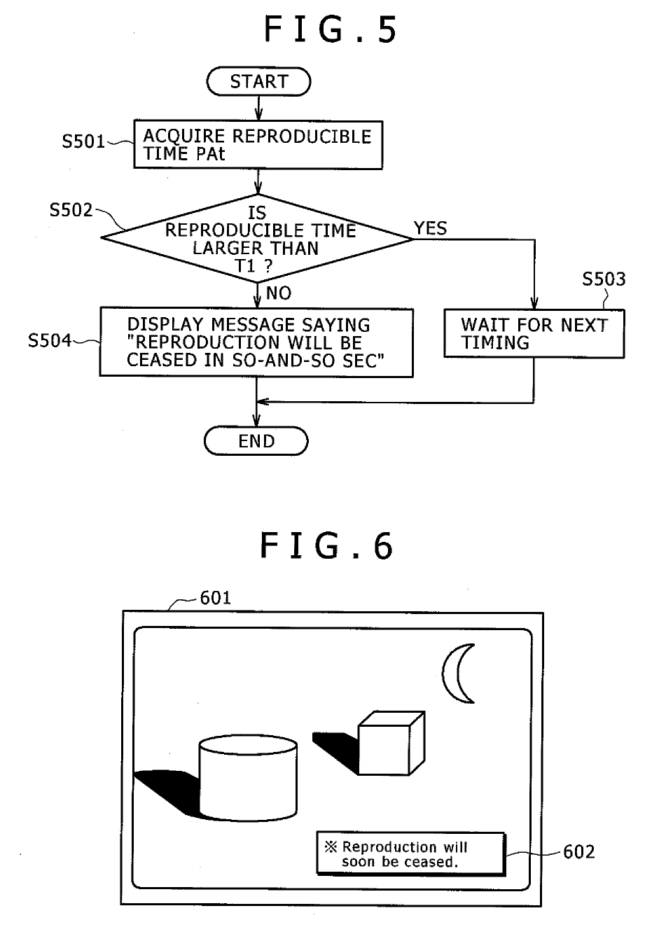

Next, a processing flow for giving a warning message to a user will be described using the reproducible time in conjunction with FIG. 5. FIG. 5 is a flowchart of a process to be followed by the system control unit 10. First, the system control unit 10 acquires a current reproducible time from the reproducible time calculation unit 31 (S501). If the reproducible time is larger than a suspension-of-reproduction threshold T1 (T1 is equal to or larger than 0) (Yes at S502), no specific processing is carried out but the next measuring timing is waited (S503). If the reproducible time is equal to or smaller than the suspension-of-reproduction threshold T1 (No at S502), a warning is given to the user by displaying a message (S504).

What is referred to as the suspension-of-reproduction threshold T1 is a value to be designated as a threshold indicating a permissible reproducible time. For example, when reproduction is performed, if processing has to be performed in units of a certain amount of data (for example, data is processed in units of 3M bytes), if an amount of recorded data falls below the certain amount of data, reproducing processing cannot be executed. Therefore, the suspension-of-reproduction threshold suitable for the recording/reproducing apparatus has to be determined. Otherwise, the suspension-of-reproduction threshold may be set to a time longer by a margin than a time determined in consideration of data processing.

The process described in the flowchart may be executed with a notification, which is sent from a time management unit 19 and signifies that a certain cycle (for example, one sec) has elapsed, as a trigger, may be executed every time the recording/reproducing control unit 13 reads data, or may be activated using a buffered quantity decrease interrupt signal sent from hardware that measures the buffered quantity of the recording buffer or reproduction buffer.

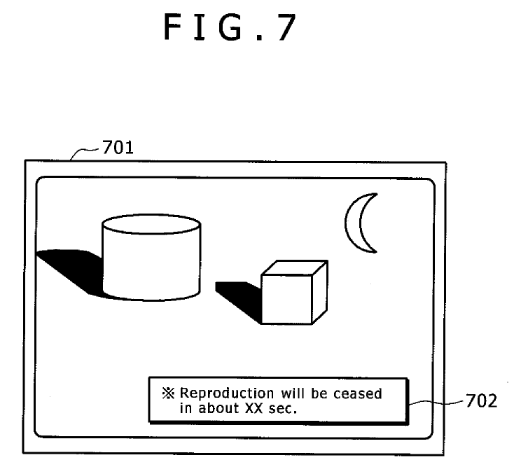

The contents of a message may, as shown in FIG. 6, signify that reproduction will be ceased or suspended in a certain time. Otherwise, a reproducible time may be, as shown in FIG. 7, indicated as a time that elapses until the cease or suspension.

When a reproducible time is equal to or shorter than a certain time, if there is a possibility that a picture may be freeze-framed, a message is displayed in advance for a user. This is advantageous because the user can prepare for the freeze-frame of the picture.

### Second Embodiment

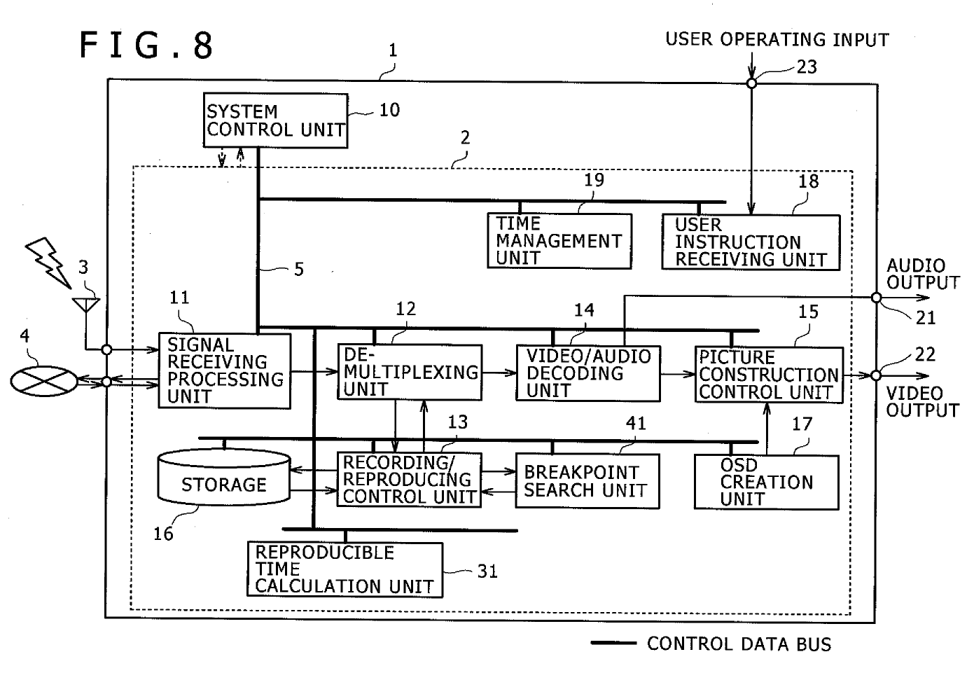

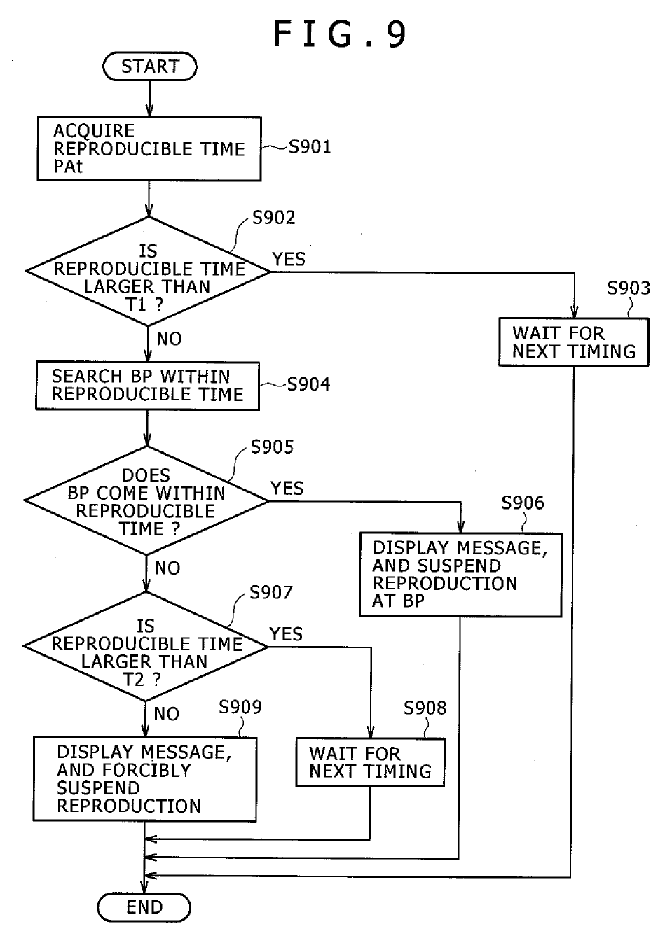

FIG. 8 shows the configuration of a recording/reproducing apparatus in accordance with the second embodiment of the present invention.

In the second embodiment, when a reproducing position approaches a recording position during follow-up reproduction, if a reproducible time becomes equal to or shorter than a certain time, reproduction is suspended with a message displayed. However, the second embodiment is characterized in that since reproduction is suspended, if possible, at a breakpoint such as the position of a chapter, reproduction can be suspended at a point at which the user can accept the suspension. As detailed later, the second embodiment is different from the first embodiment in a point that a breakpoint search unit 41 is added.

A processing flow to be followed by the system control unit 10 in the second embodiment in case a warning message is given to a user will be described in conjunction with FIG. 9. To begin with, the system control unit 10 acquires a reproducible time PAt from the reproducible time calculation unit 31 (S901). The reproducible time is calculated in the same manner as that is in the first embodiment. If the reproducible time is larger than the suspension threshold T1 (T1 is equal to or larger than 0) (Yes at S902), no specific processing is carried out (S903).

If the reproducible time is equal to or smaller than the suspension threshold T1 (No at S902), the breakpoint search unit 41 is queried whether a breakpoint comes within the reproducible time (S904). A breakpoint searching method implemented in the breakpoint search unit 41 will be described later.

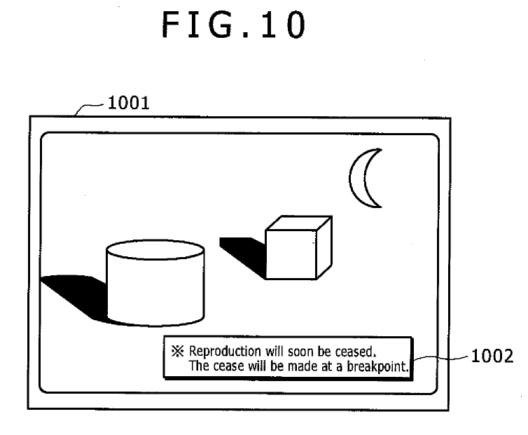

If the breakpoint BP comes within the reproducible time (Yes at S905), a message 1002 saying that reproduction will soon be ceased at a breakpoint is displayed as shown in FIG. 10, and the breakpoint BP acquired from the breakpoint search unit 41 is stored as a suspension point in the system control unit 10 (S906). If the breakpoint BP does not come within the reproducible time (No at S905), a transition is made to the next step of making a decision.

If the reproducible time is larger than a forcible suspension-of-reproduction threshold T2 (where T2 denotes a value equal to or larger than 0 and equal to or smaller than T1) (Yes at S907), no specific processing is carried out (S908). If the reproducible time is equal to or smaller than the forcible suspension-of-reproduction threshold T2 (No at S907), a message 602 like the one shown in FIG. 6 is displayed, and reproduction is suspended in a certain time after the message is displayed or suspended immediately (S909). Thus, a suspension point is designated using a breakpoint, and forcibly suspending processing is performed if the suspension point is not found.

The value of the forcible suspension-of-reproduction threshold T2 is preferably as small as possible for the apparatus. For example, if the T2 value is 0, a breakpoint can be continuously searched until a current reproduction time perfectly squares with a recording-completed time. When the T2 value equals the T1 value, if the reproducible time becomes equal to or smaller than a certain value (T1=T2), a breakpoint is searched. If no breakpoint is found, reproduction is suspended. Thus, a simple constitution ensues.

As for the reproducible time, multiple definitions are made as described in relation to the first embodiment. Assuming that the length of an unrecorded part of a content is included in the reproducible time, there is a possibility that the unrecorded part may be stored as a suspension point. Therefore, there is a possibility that reproduction may be unexpectedly suspended before it reaches a suspension point. If the length of the unrecorded part is not included in the reproducible time, since only a recorded part of the content is used as a suspension point, reproduction will not be unexpectedly suspended without reaching the part of the content designated as the suspension point. However, unlike the former case, although the suspension point comes a little later than the elapse of the recording-completed time, there is a possibility that reproduction may be suspended at a point other than a breakpoint.

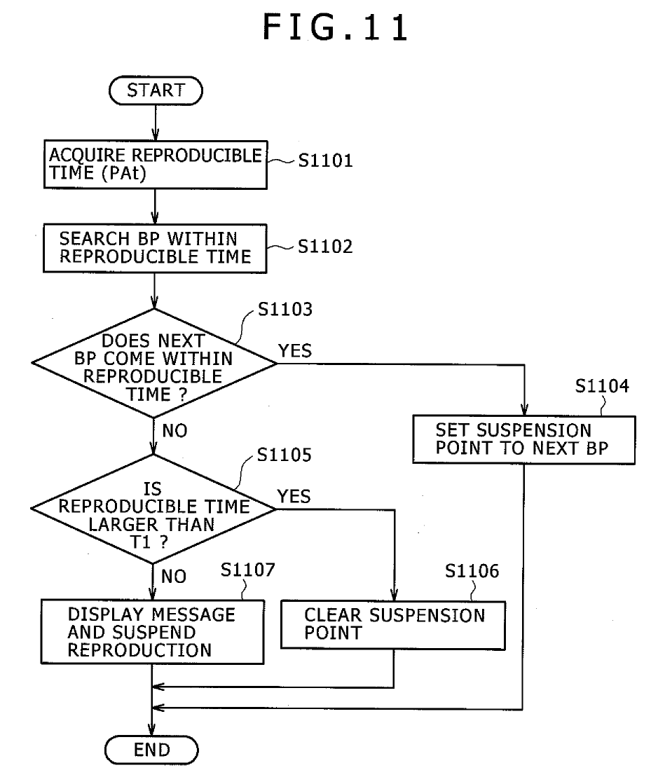

Next, a processing flow to be followed in case reproduction proceeds and a current reproduction time reaches a suspension point will be described in conjunction with FIG. 11. For detecting whether the current reproduction time has reached the suspension point, the system control unit 10 or recording/reproducing control unit 13 cyclically compares the current reproduction time with the time of the suspension point.

The system control unit 10 having performed the detection acquires the reproducible time from the reproducible time calculation unit 31 (S1101), and then queries the breakpoint search unit 41 whether a breakpoint (BP) comes within the reproducible time (S1102).

If the next BP comes within the reproducible time (Yes at S1103), the system control unit 10 stores the BP, which is acquired from the breakpoint search unit 41, as a suspension point, and waits until the current reproduction time reaches the suspension point (S1104).

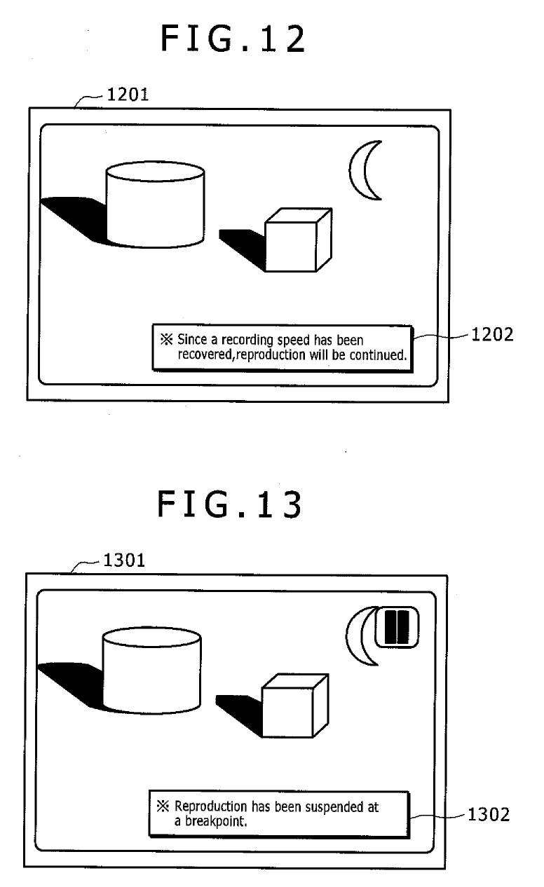

If the next BP does not come within the reproducible time (No at S1103), the reproducible time and suspension-of-reproduction threshold T1 are checked again to see if the reproducible time is larger than the suspension-of-reproduction threshold. If the reproducible time is larger than the T1 value (Yes at S1105), it means that a recording speed is restored compared with the one attained when the reproducible time is decided to be smaller than the T1 value. In this case, suspension of reproduction is not needed. Therefore, the suspension point is cleared, and a message 1202 saying that suspension is not performed is, as shown in FIG. 12, displayed for a user (S1106). Herein, the display of the message is not essential, but the message displayed at step S906 in FIG. 9 may be merely deleted. If the reproducible time is equal to or smaller than the T1 value (No at S1105), a message 1302 is displayed as shown in FIG. 13 and suspending processing is carried out (S1107).

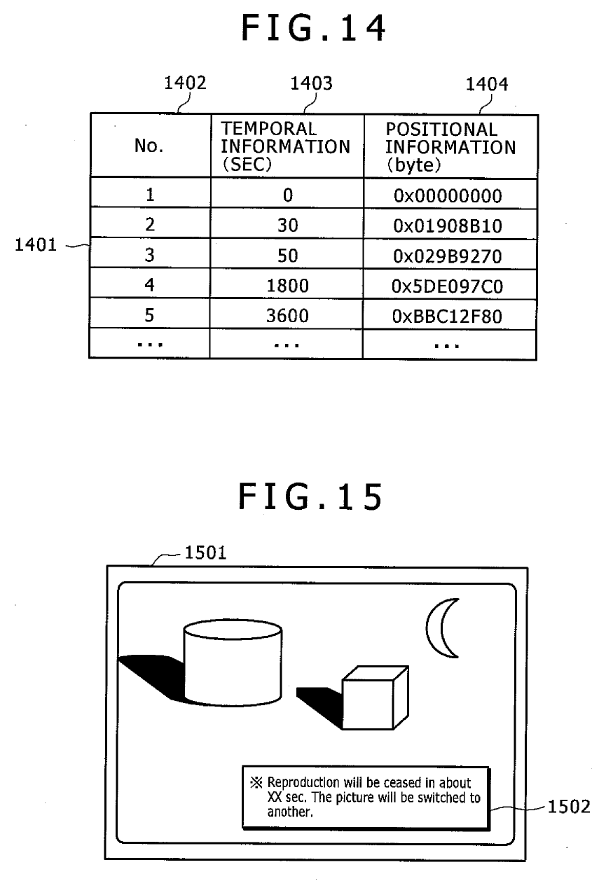

A breakpoint searching method implemented in the breakpoint search unit 41 will be described below. What can be used as a breakpoint is presumably the position of a chapter, the position of a change of scenes, the position of an instantaneous decoding refresh (IDR) picture, or the position of an intra-frame (I) picture. FIG. 14 shows an example of pieces of information on breakpoints.

Reference numeral 1401 denotes an example of a breakpoint information table in which pieces of information on breakpoints are recorded. Reference numeral 1402 denotes a number to be sequentially assigned to a breakpoint. Temporal information 1403 indicates the temporal position of each breakpoint, and positional information 1404 indicates the position in a file at which each breakpoint is present. For example, in this example, when reproduction should be initiated at a breakpoint No. 4, if reading is initiated at a position in a file indicated with the number of bytes expressed as 0x5DE097C0 in hexadecimal notation, reproduction can be initiated at the position of a predetermined breakpoint in a content. When reproduction is initiated at a position indicated with temporal information of 1800 sec, reproduction can be initiated at the position of the breakpoint in the content.

As long as the position of a chapter, the position of a change of scenes, the position of an IDR picture, or the position of an I picture is recorded in a format in which the temporal information or positional information is specified, the position can be dealt with in the same manner as the foregoing position of a breakpoint can. For example, the position of a change of scenes or the position of an I picture may be detected using some means (for example, image recognition for the change of scenes or detection of an I picture header for the I picture) during recording. The temporal information or positional information may be specified and may be recorded in the storage 16 together with a content. Otherwise, information on a chapter or the like may be acquired over the network 4. Assuming that the storage 16 is an external recording medium (for example, a DVD), information on a chapter may be recoded together with a content.

A breakpoint searching method implemented in the breakpoint search unit 41 will be described below. For example, when a request for searching whether a breakpoint comes within a reproducible time (for example, a range from 20 sec to 60 sec) is issued from the system control unit 10, if a breakpoint is detected within the reproducible time through collation with a breakpoint information table (for example, data like the breakpoint information table 1401) held in the breakpoint search unit 41, temporal information contained in association with the breakpoint is returned.

If multiple breakpoints come within a designated reproducible time, a breakpoint that comes at the latest point on a time base is returned. In the example shown in FIG. 14, 30 sec and 50 sec meet a request for the range from 20 sec to 60 sec. However, since 50 sec comes temporally later, the time is returned. If no time meets the request, a reply saying that no breakpoint comes is returned. For example, when 0 is returned, it is considered that no breakpoint comes. Herein, a query is entered in the form of an interval defined with pieces of temporal information, and temporal information is returned. Alternatively, a query may be entered in the form of an interval defined with pieces of positional information, and positional information may be returned.

In this case, as for conversion from temporal information to positional information, once the maximum values of the pieces of information are obtained, conversion can be achieved based on a ratio to each of the maximum values. For example, assuming that a content that is an object of conversion is two hours long and 20×10⁹ bytes long, since a position indicated with temporal information of 30 min corresponds to a quarter of the entire length, the temporal information is converted into positional information of a quarter position, that is, 5×10⁹ bytes.

Temporal information is expressed in the notation of sec, but may be expressed in the form of a time stamp that is updated at intervals of a specific cycle (for example, 27 MHz). In this case, assuming that the video/audio decoding unit 14 and recording/reproducing control unit 13 are engaged in control based on the time stamp, a reproducing position can be readily detected. Positional information represents a position indicated with the number of bytes. For example, assuming that a recording form for a content is the form of a TS, the positional information may represent the position of a packet that is defined in units of 188 bytes or in units of 192 bytes having the time stamp appended to the 188 bytes. This method has the merit that the number of bits to be used to represent the positional information is small. Not both the temporal information and positional information need be registered. Even when one of the temporal information and positional information is registered, no problem occurs.

The breakpoint search unit need not hold in advance a table such as the breakpoint information table. When a request for breakpoint search is issued, the recording/reproducing control unit 13 reads data of a content from the storage 16, and analyzes part of the data within the reproducible time (for example, performs image recognition or searches an I picture header) so as to search a breakpoint.

Thus, if a reproducing position is likely to overtake a recording position during follow-up reproduction, a message is displayed for a user and the reproduction is suspended. At this time, the reproduction is suspended at, if possible, a breakpoint such as the position of a chapter or the like. This is advantageous because the reproduction can be suspended at a point at which the user can accept the suspension.

### Third Embodiment

The configuration of a recording/reproducing apparatus in accordance with the third embodiment of the present invention is identical to that of the first or second embodiment. Only the contents of processing are different.

In the third embodiment, when a reproducing position approaches a recording position during follow-up reproduction, if a reproducible time becomes equal to or shorter than a certain time, the reproduction is suspended, and a temporary-reproduction content other than an image being reproduced is displayed. Therefore, not only a still image is displayed during suspension but also another content can be automatically viewed. When a user is allowed to select whether contents are switched, actions suitable for the user's likes can be performed.

A process to be followed in the case where the foregoing actions are performed in the third embodiment, and the reproducible time is used to give a warning message to a user will be described below. As the process ending with display of the warning message for a user, the process identical to the one described in the flowchart of FIG. 5 in relation to the first embodiment is carried out. When the message is displayed for a user at step S504, a message saying that pictures will be switched (1502 in FIG. 15) is displayed.

Thereafter, when reproduction is suspended, switching processing for pictures is performed.

A switching method for pictures at the time of suspension will be described below. The contents of reproduction suspending processing are identical to those described in relation to the first embodiment. A difference lies in that the system control unit 10 instructs the recording/reproducing control unit 13 to freeze-frame a picture, and instructs the recording/reproducing control unit 13 to reproduce a temporary-reproduction content. What is referred to as the temporary-reproduction content is a content to be displayed for a user instead of display of a still image, for example, a commercial, a digest of a content being viewed, a trailer of a movie, or a specific scenic image.

The recording/reproducing control unit 13 having received the suspension instruction or the reproduction instruction for the temporary-reproduction content performs suspending processing in the same manner as it does according to the method employed in the first embodiment, and thus freeze-frames a content currently being viewed. The recording/reproducing control unit 13 reads the temporary-reproduction content from the storage 16 or any other place (for example, an external medium connected to the recording/reproducing apparatus 1 or a built-in memory), and performs the aforesaid processing. Thus, when reproduction is suspended, pictures are switched in order to display the temporary-reproduction content for a user.

The temporary-reproduction content may not be read from the storage but may be a picture obtainable from the signal receiving processing unit 11 (for example, a broadcast program) In this case, the system control unit 10 instructs the signal receiving processing unit 11 to select a specific channel (for example, a program which a user has viewed immediately before reproduction) instead of instructing the recording/reproducing control unit 13 to reproduce the temporary-reproduction content. After the demultiplexing unit 12 performs demultiplexing or any other processing on a signal inputted from the receiving processing unit 11, the resultant signal is outputted to the video/audio decoding unit 14. Thus, a current broadcast program can be viewed during suspension.

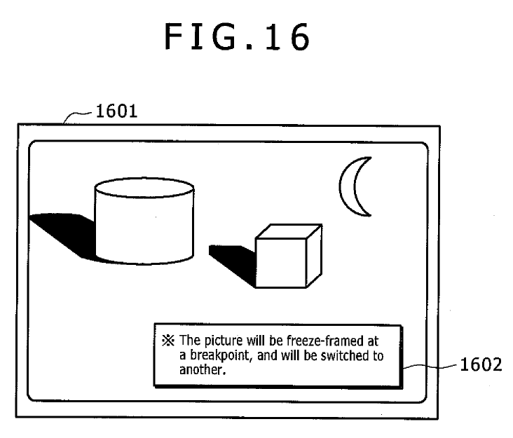

When a decision is made in the same manner as it is in the second embodiment, if reproduction is suspended at a breakpoint, the message 1602 like the one shown in FIG. 16 is displayed. Pictures are switched according to the switching method for pictures, which is applied to a case where reproduction is suspended, in the same manner as those in the aforesaid processing.

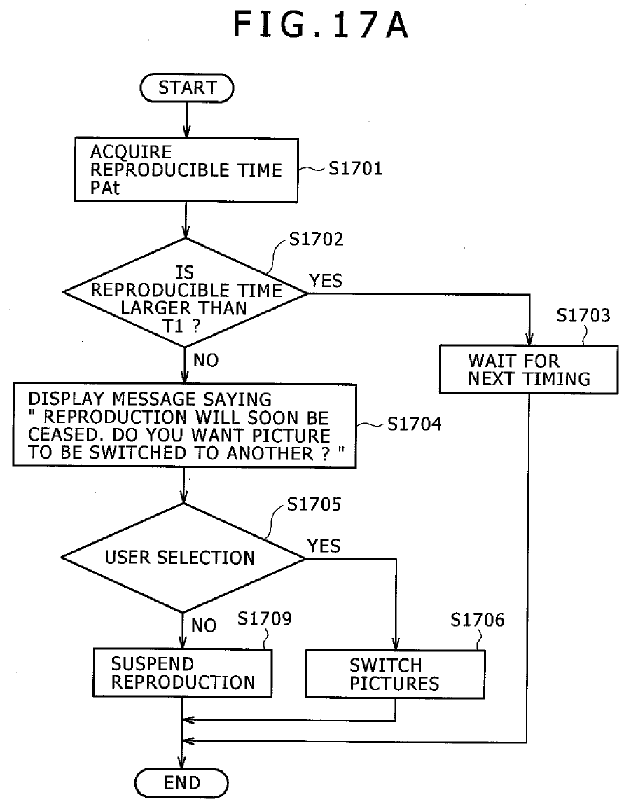

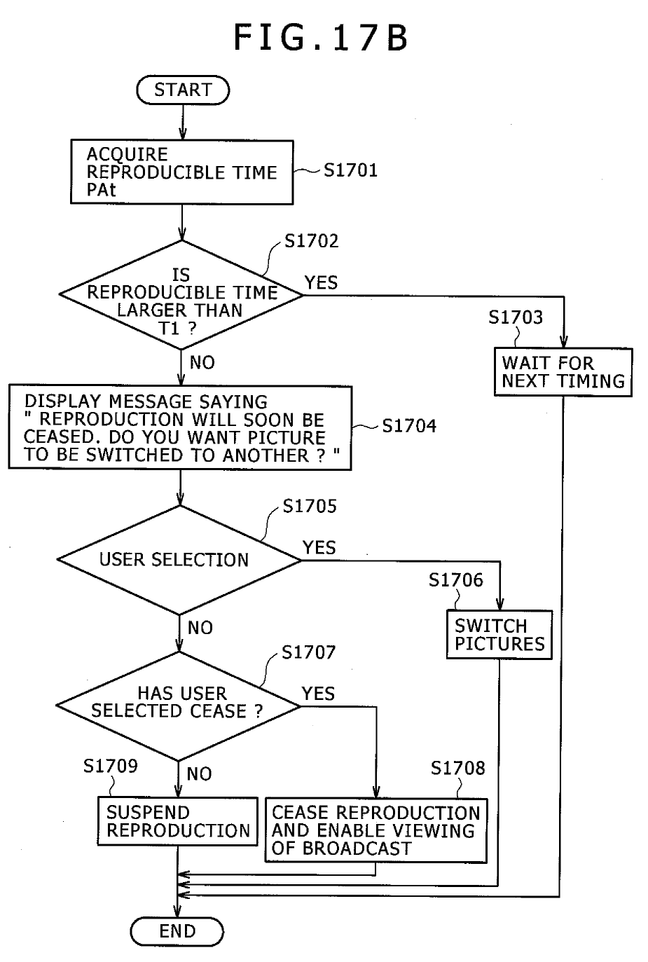

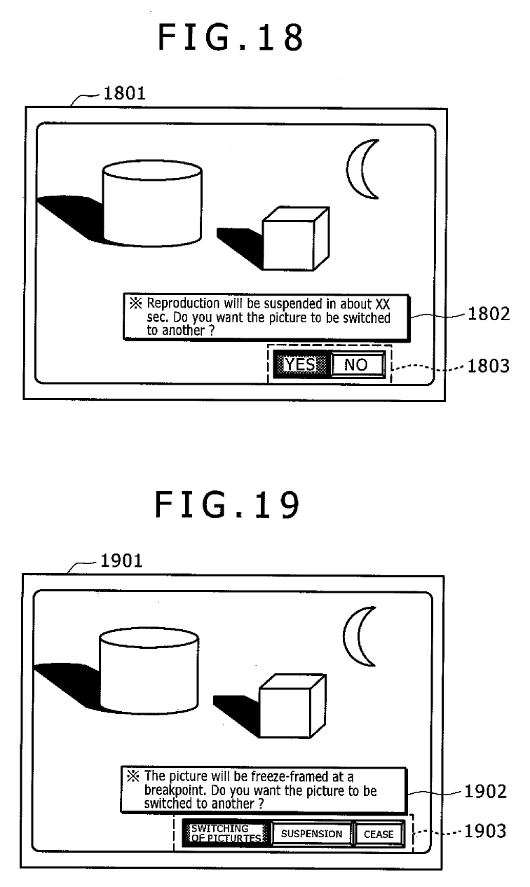

A case where a user designates whether pictures should be switched will be described in conjunction with the flowchart of FIG. 17A. A decision is made in the same manner as that is in the first embodiment. When a message saying that reproduction will soon be suspended is displayed for a user, not only the message saying that reproduction will be suspended is displayed but also a message 1802 asking what processing should be performed after suspension and buttons 1803 selectable by a user are displayed as shown in FIG. 18 (S1704).

A user manipulates the buttons 1803 so as to select what temporary-reproduction content should be reproduced after suspension or whether a still image should be displayed. For example, assuming that the user operates a remote control or the like to select Yes with one of the buttons 1803 (for example, the right and left arrow keys are used to highlight Yes, and a Determine key (OK key) is depressed). Assuming that the user selects switching of pictures, processing is performed on, for example, the temporary-reproduction content. When No is selected with the other one of the buttons 1803, since the user has selected suspension, processing is performed on a still image or the like for suspension.

The indications of the buttons are not limited to Yes and No, but may express suspension-related actions which a user likes. FIG. 19 shows an example of display applied to such a case. If a user depresses one of buttons 1903, processing is performed on the assumption that the user has selected as a suspension-time action any of switching of pictures, suspension, and cease which are displayed in that order from the left.

In FIG. 19, switching of pictures, suspension, and cease are broadly interpreted as suspension-time actions. However, a case where reproduction is suspended and a still image is displayed is often narrowly referred to as suspension. Accordingly, the buttons 1903 in FIG. 19 have the indications.

The above case will be described in conjunction with the flowchart of FIG. 17B. A decision is made in the same manner as it is in the first embodiment. A message saying that reproduction will soon be suspended is displayed for a user. At this time, as shown in FIG. 19, not only the message saying that reproduction will be suspended is displayed but also a message 1902 asking what processing should be performed after suspension and the buttons 1903 any of which a user can select are displayed (S1704).

Thereafter, if the user's selection is switching of pictures (Yes at S1705), processing is performed in order to display a temporary-reproduction content in the same manner as described previously (S1706).

If a suspension-time action is other than switching of pictures (No at S1705), a process proceeds as described below. If a user's selection is cease (Yes at S1707), processing is performed in order to display a current broadcast program during suspension (S1708). If the user's selection is suspension (No at S1707), suspending processing described in relation to the first embodiment is carried out, and processing is performed in order to display a still image (S1709). Thus, switching processing for pictures is carried out according to a result of user selection.

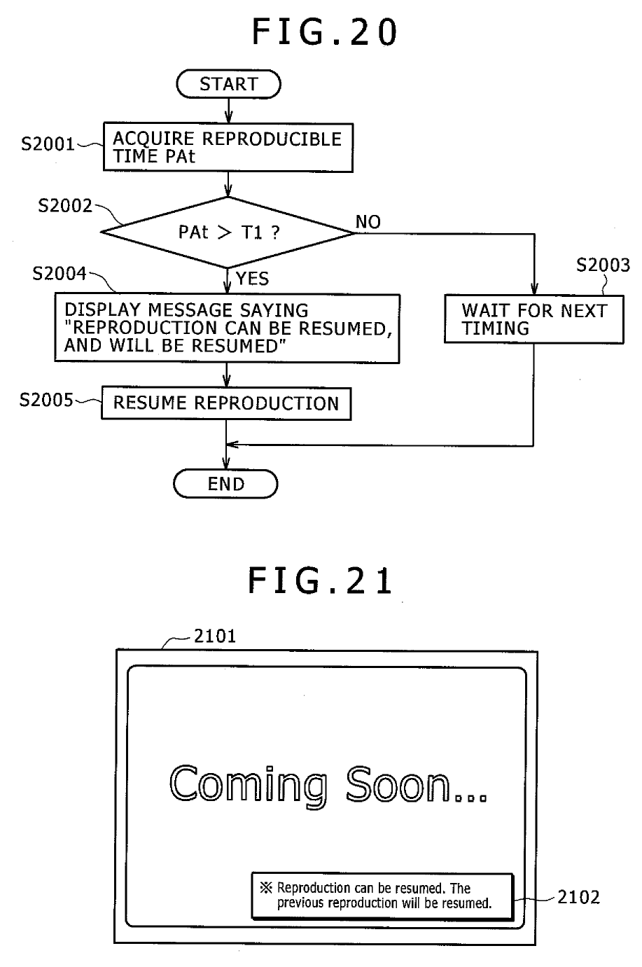

A process to be followed in the case where after picture switching processing is performed, a displayed picture is restored to a content whose reproduction has been suspended, will be described in conjunction with the flowchart of FIG. 20. After a picture is switched to a temporary-reproduction content or a broadcast according to the foregoing method, every time a certain time (for example, one sec) elapses, the system control unit 10 receives a notification from the time management unit, and executes the process described in FIG. 20.

To begin with, the system control unit 10 acquires the reproducible time PAt from the reproducible time calculation unit 31 (S2001). If the reproducible time exceeds the suspension-of-reproduction threshold T1 (Yes at S2002), since reproduction can be resumed, a message 2102 like the one shown in FIG. 21 is displayed in order to notify a user that reproduction can be resumed (S2004). Reproduction is then resumed (S2005). As for reproduction resuming processing, it is identical to the resuming processing from a suspended state described in relation to the first embodiment.

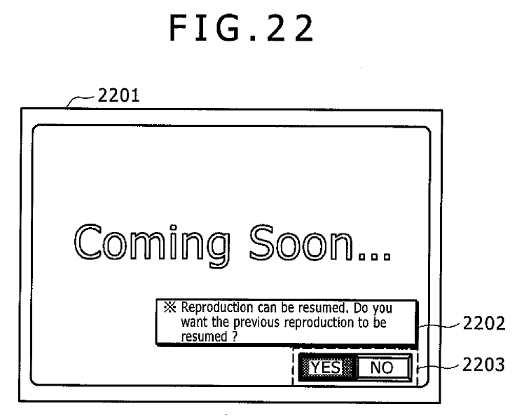

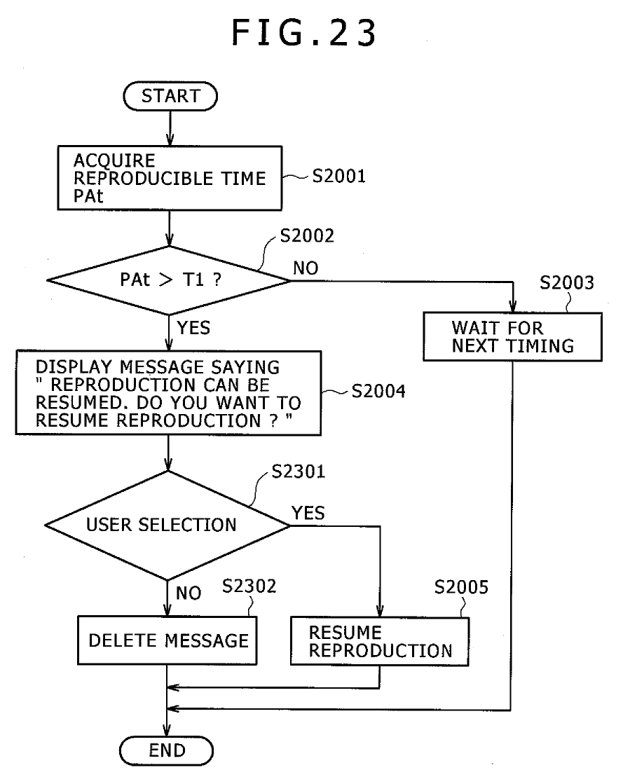

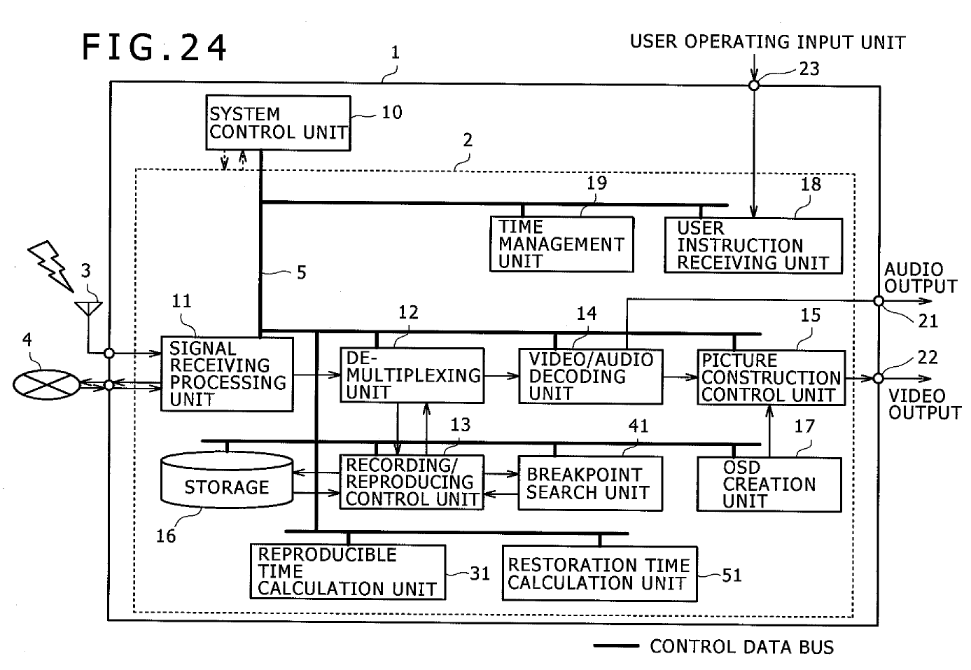

As for the contents of display of a message, for example, as shown in FIG. 22, a message asking a user whether previous reproduction should be resumed may be displayed. In this case, a processing flow is as described in the flowchart of FIG. 23, and a branch of step S2301 is added. If the user selects No, the message is deleted, and no processing is performed thereafter. Otherwise, the message is displayed again in a certain time. Otherwise, if a temporary-reproduction content is stopped, the message may be displayed again.

The result of user selection made this time shall be called a suspension-reset time action. For example, if a user selects Yes, the suspension-reset time action is resumption of reproduction. If the user selects No, the suspension-reset time action is continuation of suspension.

Herein, as the suspension threshold, the same value as the one used at the time of suspension may be used in the same manner as it is in the first embodiment. Alternatively, another value may be adopted.

The user selection to be performed at the time of suspension or the user selection of the suspension-reset time action need not be performed by a user every time, but may be designated in advance so that processing can be automatically performed based on the designation.

Thus, when reproduction almost comes up with recording during follow-up reproduction, the reproduction is suspended and a temporary-reproduction content is displayed during the suspension. This is advantageous because not only a still image is displayed for a user during suspension but also any other content can be automatically viewed.

There is another advantage that when a user is allowed to select whether a content should be switched to a temporary-reproduction content or reproduction should be resumed from the temporary-reproduction content, actions suitable for the user's likes can be carried out.

Herein, a case where switching processing for pictures to be performed during suspension is applied to the first embodiment has been described. The same switching processing may be applied to the second embodiment.

### Fourth Embodiment

FIG. 24 shows the configuration of a recording/reproducing apparatus in accordance with the fourth embodiment of the present invention.

In the fourth embodiment, when a reproducing position approaches a recording position during follow-up reproduction, if a reproducible time becomes equal to or shorter than a certain time, reproduction is suspended. At this time, an expected restoration time is calculated. This is characterized in that a user can select his/her actions. For example, if it takes a long time to reach a restoration time instant, a user can do other work. If it takes a short time to reach the restoration time instant, the user may wait for resumption. As detailed later, the present embodiment is different from the aforesaid embodiments in that a restoration time calculation unit 51 is added.

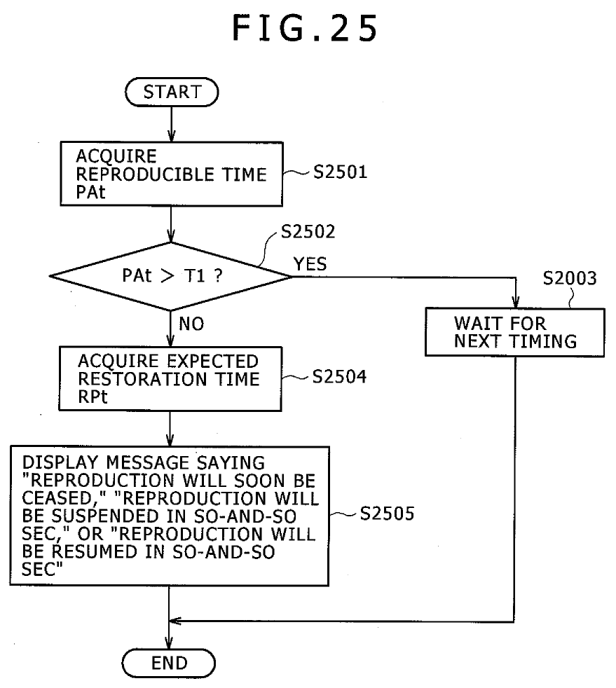

A process to be followed in the case where a warning is given to a user by displaying a message will be described in conjunction with the flowchart of FIG. 25. First, a reproducible time is acquired from the reproducible time calculation unit 31 (S2501). If the reproducible time is equal to or smaller than the suspension-of-reproduction threshold T1 (No at S2502) and a warning is given to a user by displaying a message, an expected restoration time (RPt) is acquired from the restoration time calculation unit 51 (S2504).

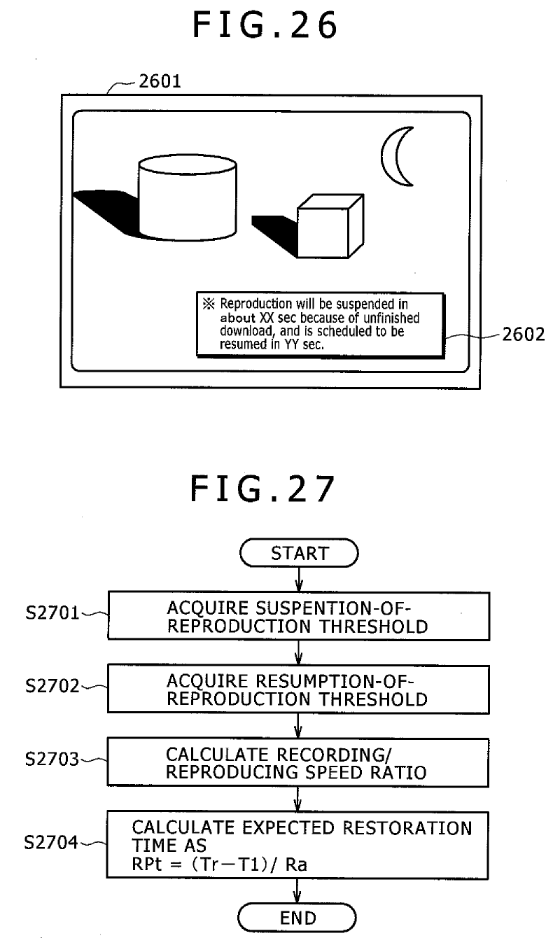

What is referred to as the expected restoration time is an estimated time that is required until reproduction can be resumed after the reproduction is suspended. A calculating method for the expected restoration time will be described later. The system control unit 10 having acquired the expected restoration time displays a warning message 2602 like the one shown in FIG. 26, which contains the reproducible time and expected restoration time, for a user (S2505).

Herein, an example of a message containing both the reproducible time and expected restoration time is presented. Displaying only one of the reproducible time and expected restoration time is conceivable. Alternatively, the sum of the reproducible time and expected restoration time may be displayed in order to indicate in what seconds from now on reproduction is suspended and then resumed.

As mentioned above, when a reproducible time becomes equal to or shorter than a certain time, if there is a possibility that a picture may be freeze-framed, since a message is displayed in advance for a user, the user can prepare for the freeze-frame of the picture. When a restoration time is displayed, if it takes a long time to reach a restoration time instant, the user can do other work. If it takes a short time to reach the restoration time instant, the user may wait for resumption. Thus, this is advantageous because a user can select his/her actions.

A calculating method for the expected restoration time will be described in conjunction with the flowchart of FIG. 27. First, the restoration time calculation unit 51 acquires the suspension-of-restoration threshold T1 from the system control unit 10 (S2701). Thereafter, the restoration time calculation unit 51 acquires a resumption-of-restoration threshold Tr (S2702).

What is referred to as the resumption-of-restoration threshold is a difference time between a recording-completed time and a current reproduction time and is used to decide whether reproduction can be resumed. A way of determining the resumption-of-reproduction threshold Tr will be described below. For example, when the resumption-of-reproduction threshold Tr is set to a small value (for example, 0), there is a possibility that display like frame-by-frame reproduction may be carried out, that is, reproduction may be ceased immediately after it is resumed. In contrast, when the resumption-of-reproduction threshold Tr is set to a large value, a drawback that after reproduction is suspended, although recording proceeds, reproduction is not resumed for some time takes place. By achieving trade-off, the resumption-of-reproduction threshold Tr has to be set to an optimal value.

Thereafter, the recording/reproducing speed ratio Ra per unit time for a content is calculated according to the same method as the method employed in the first embodiment (S2703). The expected restoration time RPt is then calculated using the foregoing values as follows:

RPt=(Tr−T1)/Ra

where Tr−T1 expresses a time by which the recording-completed time should be increased in order to enable reproduction that is in a suspended state. The time is divided by the recording/reproducing speed ratio Ra per unit time for a content, whereby the expected restoration time can be obtained (S2704).

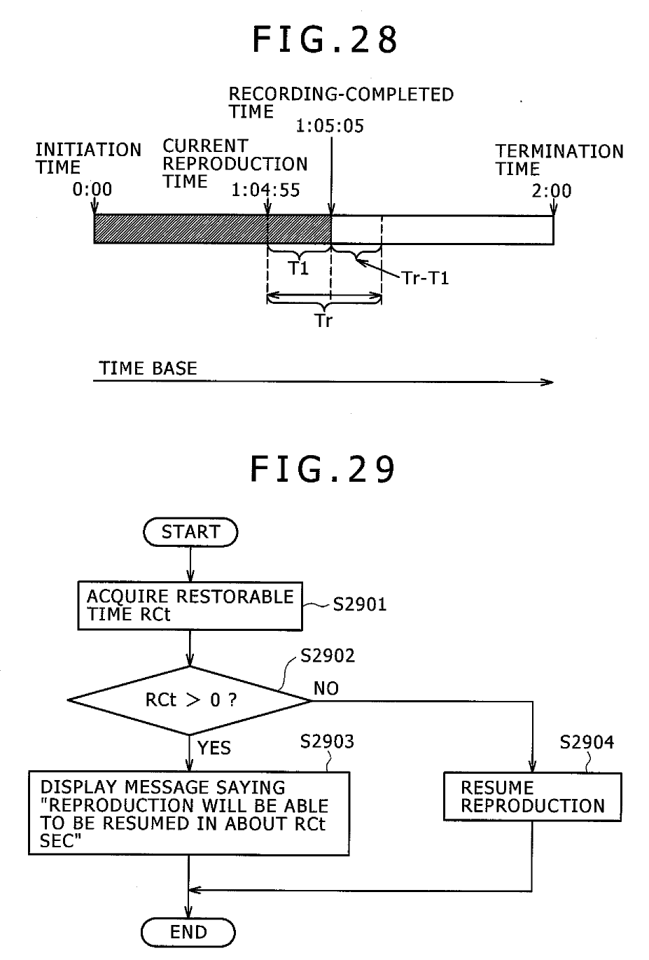

The expected restoration time will be described again using an example shown in FIG. 28. A laterally elongated square in the center of FIG. 28 expresses content data. An entire content is two hours long. The leftmost end of the square indicates an initiation time, and the rightmost end thereof indicates a termination time. In this example, one hour, five minutes, and five seconds elapsing from the initiation time of the content of two hours long has recording thereof completed. The recording-completed part of the content data is expressed with a hatched area. Follow-up reproduction is performed on the same content, and has been completed up to the time point at which one hour, four minutes, and fifty-five seconds has elapsed. Herein, an instant at which reproduction is suspended is expressed. In this case, Rt−Pt=T1 is established. Herein, Tr−T1 expresses a period shown in the drawing. If recording is performed during the period, the content would be recorded for a time permitting resumption. Therefore, reproduction can be resumed. Namely, since the content should be recorded so that it can be reproduced for the time of Tr−T1, if the time that is expressed as RPt=(Tr−T1)/Ra using the recording/reproducing speed ratio Ra per unit time of a content elapses, reproduction is expected to be enabled.

Herein, a description has been made of a case where a difference time between a recording-completed time and a current reproduction time that is expected to exceed the Tr value is regarded as the expected restoration time. Alternatively, the reproducible time expected to exceed the Tr−T1 value may be regarded as the expected restoration time.

Next, reproduction resuming processing to be performed after reproduction is suspended will be described below. Herein, after reproduction is suspended, when the difference between the recording-completed time Rt and current reproduction time Pt has exceeded the resumption-of-reproduction threshold Tr, reproduction is resumed.

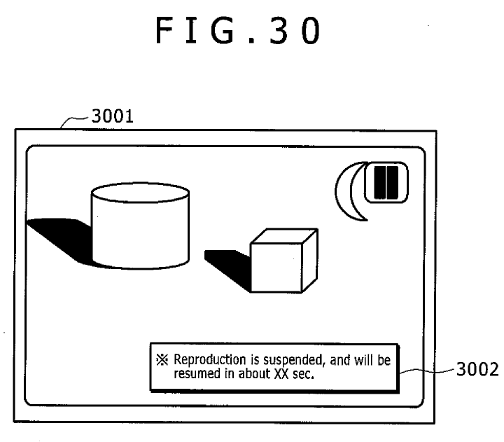

The contents of a process to be followed during suspension according to the fourth embodiment will be described in conjunction with the flowchart of FIG. 29. To begin with, the system control unit 10 acquires a restorable time (RCt) from the restoration time calculation unit 51 (S2901). What is referred to as the restorable time RCt is a time estimated to elapse from a current state until reproduction is resumed. The calculating method will be described later. If the restorable time RCt is larger than 0 (Yes at S2902), reproduction cannot be resumed yet. The restorable time RCt is displayed or updated. A message 3002 containing the time, which will be required until reproduction can be resumed, like the one shown in FIG. 30 is displayed (S2903). If the restorable time is 0 (No at S2902), the timing when reproduction can be restored has come. Therefore, the resuming processing from a suspended state described in relation to the first embodiment is carried out in order to resume reproduction (S2904). At this time, a message saying that reproduction will be resumed may be displayed. Thus, an estimated time that will be required until the original state is restored and reproduction can be performed is displayed for a user.

The process to be followed during suspension may be executed with a notification, which signifies that a certain cycle (for example, one sec) has elapsed and is sent from the time management unit 19, as a trigger, or may be executed every time the recording/reproducing control unit 13 writes data. The process to be followed during suspension may be activated using hardware that measures a buffered quantity of the recording buffer or reproduction buffer, and a buffered quantity increasing interrupt signal sent from the hardware, or may be activated when a variable such as the recording/reproducing speed ratio Ra per unit time of a content has changed from one value to another. Otherwise, when the process to be followed during suspension is activated with a variation in a variable, which is employed in calculation of the restorable time RCt, as a trigger, the restorable time concerning the latest state can be displayed for a user.

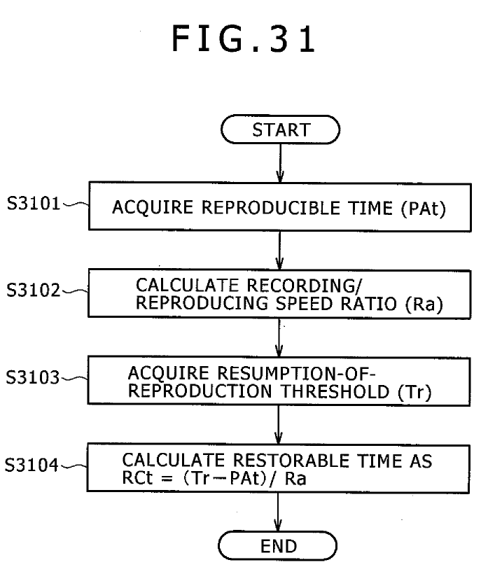

A method of calculating the restorable time RCt in the restoration time calculation unit 51 will be described in conjunction with FIG. 31.

To begin with, the restoration time calculation unit 51 acquires the reproducible time PAt from the reproducible time calculation unit 31 (S3101), and acquires the recording/reproducing speed ratio Ra for a content from the reproducible time calculation unit 31 (S3102). Thereafter, the restoration time calculation unit 51 acquires the resumption-of-reproduction threshold Tr from the system control unit 10 (S3102). These values are used to calculate the restorable time RCt (S3104). The restorable time RCt can be calculated by dividing the difference between the resumption-of-reproduction threshold Tr and reproducible time PAt by the recording/reproducing speed ratio Ra for a content as expressed below.

RCt=(Tr−PAt)/Ra

As another calculating method, the reproducible time PAt is not used, but the difference between a current recording-completed time Rt and a current reproduction time Pt that exceeds the resumption-of-reproduction threshold Tr may be divided by the recording/reproducing speed ratio Ra as expressed below.

RCt=(Tr−(Rt−Pt))/Ra

In this case, an increase in a content occurring from now on is not taken into account. Therefore, this method has the demerit that even when the Ra value is larger than 1 or even when the recording speed is much higher than the reproducing speed, that is, even when reproduction can be resumed, reproduction may not be resumed. However, the method has the merit that calculation is easy to do.

Herein, the restorable time is indicated as a time expressed in the unit of sec. An indication other than the time may be employed. For example, the time required until reproduction can be resumed may be counted down by setting a threshold to an appropriate time (for example, when the time falls within thirty sec, 5 is displayed. When the time falls below five sec, 1 is displayed.). Alternatively, when the time required until reproduction can be resumed falls below a specific threshold, an icon expressing the information may be displayed (for example, when the restorable time is equal to or shorter than three sec, an icon expressing reproduction may be flickered in order to notify a user of the fact that reproduction will soon be resumed.).

The time indicated herein, that is, the restorable time need not always be calculated according to the aforesaid method every time display is updated. For example, a notification that a certain cycle (for example, one sec) has elapsed and that is sent from the time management unit 19 is used as a trigger to display the restorable time from which the time of the certain cycle is subtracted. In this case, the number of calculations may be small. However, when a variable such as the Ra value is changed from one value to another, there is a possibility that an incorrectly calculated restorable time may be displayed.

A description has been made of a case where the expected restoration time and restorable time are applied to the constitution of the first embodiment. The expected restoration time and restorable time can be applied to the second or third embodiment. In this case, when a message saying that restoration will soon be suspended is displayed, the expected restoration time is displayed. After the suspension, when a message is displayed for a user, the restorable time is displayed. The other constituent features are not especially modified.

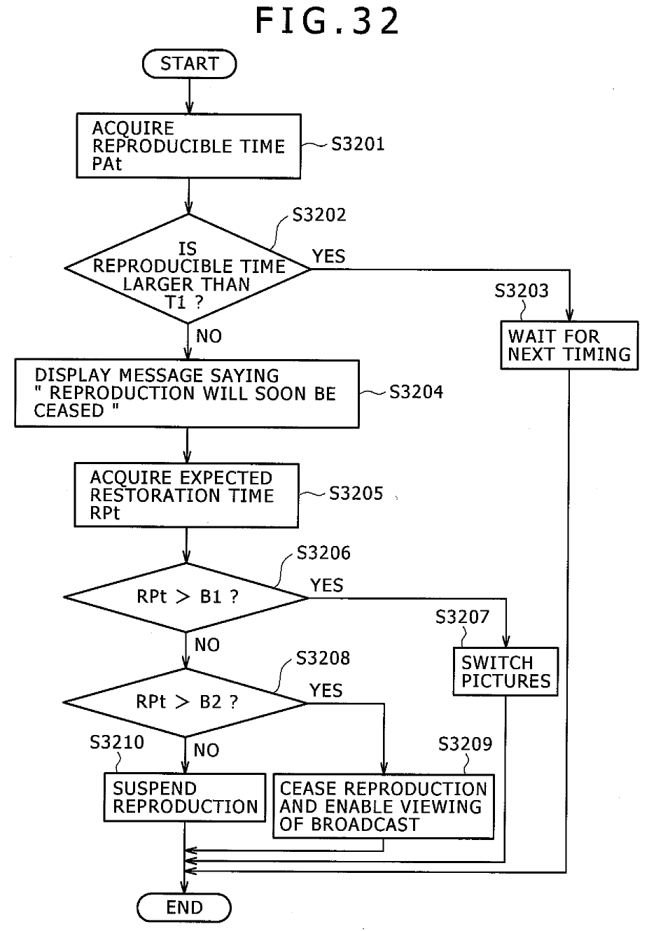

As an example in which the foregoing constituent feature is added to the third embodiment, a method of automatically deciding a suspension-time action using an expected restoration time is conceivable. The contents of the process will be described in conjunction with the flowchart of FIG. 32. When a reproducible time is equal to or smaller than the T1 value (No at S3202), a message is displayed (S3204) and the expected restoration time RPt is acquired (S3205). If the expected restoration time RPt is larger than a picture switching processing threshold B1 (Yes at S3206), picture switching processing for switching to the aforesaid temporary-reproduction content is carried out (S3207). If the RPt value is equal to or smaller than the picture switching processing threshold B1 (No at S3206), a decision is made as described below. Specifically, if the RPt value is larger than a ceasing processing threshold B2 (B2<B1) (Yes at S3208), the processing of ceasing reproduction as described previously so that a current broadcast program can be viewed is carried out (S3209). If the RPt value is equal to or smaller than the ceasing processing threshold B2 (No at S3208), the processing of displaying a still image as described previously is carried out (S3210). Thus, when the reproducible time becomes equal to or smaller than a certain threshold, an action to be performed during suspension can be changed from one to another using the expected restoration time.

Herein, picture switching processing, ceasing processing, and suspending processing are performed in descending order of the expected restoration time. The order can be arbitrarily modified. For example, the ceasing processing, picture switching processing, and suspending processing may be performed in descending order of the expected restoration time. However, when the expected restoration time is short, the suspending processing should preferably be performed. Moreover, the thresholds B1 and B2 can be set to arbitrary values.

As for the order of the pieces of processing and the set values, for example, a user can determine them in advance.

The embodiments of the present invention have been described so far. The description is not intended to restrict pieces of processing to be performed in the embodiments. Pieces of processing to be performed in the embodiments may be chosen and arbitrarily combined.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. A recording/reproducing method for recording information on an inputted picture and sounds in a recording medium and concurrently reproducing recorded information from the recording medium so as to output the information to outside, comprising:
a first calculation step of calculating a reproducible time during which information can be reproduced until a reproducing position overtakes a recording position;
a comparison step of comparing the reproducible time with a predetermined value;
a control step of controlling a recording/reproducing action,
wherein if a decision is made at the comparison step that the reproducible time is equal to or smaller than the predetermined value, reproduction is suspended at the control step.

2. The recording/reproducing method according to claim 1, further comprising a display step of displaying a message for a user,
wherein if a decision is made at the comparison step that the reproducible time is equal to or smaller than the predetermined value, the display step is used to display the fact.

3. The recording/reproducing method according to claim 1, wherein at the first calculation step, the reproducible time is calculated based on a recording speed at which data is recorded per unit time.

4. The recording/reproducing method according to claim 1, wherein at the first calculation step, an input rate at which a digital signal is inputted is used to calculate the reproducible time.

5. The recording/reproducing method according to claim 1, further comprising a search step of searching a breakpoint that is contained in the information and that refers to a position at which scenes are changed,
wherein when a decision is made at the comparison step that the reproducible time is equal to or smaller than the predetermined value and a decision is made at the search step that the breakpoint comes within the reproducible time, reproduction is suspended at the breakpoint within the reproducible time at the control step.

6. The recording/reproducing method according to claim 1, further comprising:
a first switch step of switching actions of outputting information to outside; and
a temporary reproduction step of reproducing a temporary-reproduction content that is prepared separately,
wherein if a decision is made at the comparison step that the reproducible time is equal to or smaller than the predetermined value, information to be outputted to outside is switched to the temporary-reproduction content, which is reproduced at the temporary reproduction step, at the first switch step.

7. The recording/reproducing method according to claim 1, further comprising:
a first switch step of switching actions of outputting information to outside; and
a first selection step at which a user selects one of the actions of outputting information to outside during suspension,
wherein if a decision is made at the comparison step that the reproducible time is equal to or smaller than the predetermined value, an action of outputting information to outside is switched to an action, which the user has selected at the first selection step, at the first switch step.

8. The recording/reproducing method according to claim 7, wherein the actions one of which a user selects include two or more out of reproduction of a temporary-reproduction content to be displayed during suspension, cease of reproductive output, and reproduction of a still image during suspension.

9. The recording/reproducing method according to claim 7, wherein a user can designate a suspension-time action in advance before the reproducible time becomes equal to or smaller than the predetermined value.

10. The recording/reproducing method according to claim 6, further comprising a resumption-of-reproduction step of canceling a suspended state and resuming reproduction,
wherein if a decision is made at the comparison step that the reproducible time becomes larger than the predetermined value, suspension is canceled in order to resume reproduction at the resumption-of-reproduction step.

11. The recording/reproducing method according to claim 6, further comprising:
a resumption-of-reproduction step of canceling a suspended state and resuming reproduction; and
a second selection step at which a user can select whether resumption of reproduction should be activated,
wherein if a decision is made at the comparison step that the reproducible time becomes larger than the predetermined value, an action is performed at the resumption-of-reproduction step according to the user selection made at the second selection step.

12. The recording/reproducing method according to claim 11, wherein a user can designate a suspension-reset time action in advance before the reproducible time becomes equal to or smaller than the predetermined value.

13. The recording/reproducing method according to claim 2, further comprising a second calculation step of calculating an expected restoration time that elapses from a time point, at which a suspended state is established, to a time point at which a reproducible state is expected to be restored,
wherein the display step is used to provide a display containing the expected restoration time.

14. The recording/reproducing method according to claim 2, further comprising a third calculation step of calculating a restorable time that elapses from a certain time point succeeding establishment of a suspended state to a time point at which a reproducible state can be restored,
wherein the display step is used to provide a display containing the restorable time.

15. The recording/reproducing method according to claim 13, further comprising a second switch step of switching pieces of information, which are outputted to outside, according to a length of the expected restoration time.

16. A recording/reproducing apparatus that records information on an input picture and sounds in a recording medium and concurrently reproduces recorded information from the recording medium so as to output the information to outside, comprising:
a reproducible time calculation unit that calculates a reproducible time during which information can be reproduced until a reproducing position overtakes a recording position;
a reproducible time comparison unit that compares the reproducible time with a predetermined value; and
a recording/reproducing control unit that controls a recording/reproducing action,
wherein if a decision is made in the reproducible time comparison unit that the reproducible time is equal to or smaller than the predetermined value, the recording/reproducing control unit suspends reproduction.

17. The recording/reproducing apparatus according to claim 16, further comprising a display unit that displays a message for a user,
wherein if a decision is made in the reproducible time comparison unit that the reproducible time is equal to or smaller than the predetermined value, the display unit is used to display the fact.

18. The recording/reproducing method according to claim 16, further comprising a breakpoint search unit that searches a breakpoint that is contained in the information and that refers to a position at which scenes are changed,
wherein when a decision is made in the reproducible time comparison unit that the reproducible time is equal to or smaller than the predetermined value and a decision is made in the breakpoint search unit that the breakpoint comes within the reproducible time, the recording/reproducing control unit suspends reproduction at the breakpoint.
